(19) United States
(12) Patent Application Publication
(10) Pub. No.: US 2009/0122100 A1
(43) Pub. Date: May 14, 2009

(54) HEAD UNIT AND METHOD OF MANUFACTURING THE SAME

(75) Inventor: Shinichiro Hida, Numazu-shi (JP)

Correspondence Address: AMIN, TUROCY & CALVIN, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/173,450

(22) Filed: Jul. 15, 2008

(30) Foreign Application Priority Data
Nov. 9, 2007 (JP) 2007-292393

(51) Int. Cl. B41J 2/015; B23P 17/00

(52) U.S. Cl. 347/20; 29/890.1

(57) ABSTRACT

A head unit includes a base, an inkjet head, a first bonding portion, and a second bonding portion. The inkjet head is attached to the base, and discharges ink droplets. The first bonding portion bonds the base to the inkjet head in a spot manner. The second bonding portion is disposed to surround the first bonding portion. The second bonding portion bonds the base to the inkjet head, and has resistance to ink.

### CROSS-REFERENCE TO RELATED APPLICATIONS

This application is based upon and claims the benefit of priority from prior Japanese Patent Application No. 2007-292393, filed Nov. 9, 2007, the entire contents of which are incorporated herein by reference.

### BACKGROUND OF THE INVENTION

1. Field of the Invention

The present invention relates to a head unit which has an on-demand inkjet head, and a method of manufacturing the same.

2. Description of the Related Art

For example, Jpn. Pat. Appln. KOKAI Pub. No. 9-141863 discloses an inkjet head using a piezoelectric element as a drive element for ink discharge. The inkjet head has an orifice serving as an ink jet port, an ink chamber which communicates with the orifice and in which ink is stored, a piezoelectric element to apply pressure to the ink chamber, a wall member which is made of silicone rubber and divides the ink chamber from the piezoelectric element, and an ink-resistant protective film provided between the ink chamber and the wall member. The ink-resistant protective film is formed by applying, for example, an epoxy-based adhesive dissolved in a solvent to the wall member.

The inkjet head prevents ink from affecting the wall member made of silicone rubber, by the ink-resistant protective film provided between the ink chamber and the wall member.

In the meantime, there are cases where it is desired to form a head unit having an inkjet head and a base supporting the head. In theses cases, there is a way of using an ink-resistant adhesive, such as a thermosetting adhesive, for bonding between the inkjet head and the base.

Generally, the base formed of metal or the like has a different coefficient of linear expansion from that of the inkjet head formed of PZT or the like. Further, when bonding is performed by using a thermosetting adhesive, a heating process for curing the adhesive is indispensable. The adhesive is cured in the state where the base and the inkjet head are expanded by heat. Therefore, when the bonded base and the inkjet head are returned to room temperature, warping and displacement may occur in the bonding portion between them, and the bonding portion may flake off, since the contraction amount differs between the base and the inkjet head.

On the other hand, when a UV-curable adhesive is used, bonding can be performed at room temperature with high accuracy. However, UV-curable adhesives are corroded by solvent-based ink, and thus cannot be used without treatment.

### BRIEF SUMMARY OF THE INVENTION

An object of the present invention is to provide a head unit in which an inkjet head and a base can be bonded to each other in a state of being positioned with high accuracy, while resistance to ink is maintained.

An object of the present invention is to provide a method of manufacturing a head unit in which an inkjet head and a base can be bonded to each other in a state of being positioned with high accuracy, while resistance to ink is maintained.

To achieve the above object, a head unit according to an aspect of the present invention comprises: a base; an inkjet head which is attached to the base and discharges ink droplets; a first bonding portion which bonds the base to the inkjet head in a spot manner; and a second bonding portion which is disposed to surround the first bonding portion, bonds the base to the inkjet head, and has resistance to ink.

To achieve the above object, a method of manufacturing a head unit according to an aspect of the present invention is a method of manufacturing a head unit having a base and an inkjet head attached to the base, comprising: applying a first adhesive, which is curable at room temperature, between the base and the inkjet head, curing the first adhesive at room temperature, thereafter applying a thermosetting second adhesive in the vicinity of the first adhesive, and heating the head unit and thereby curing the second adhesive to surround the first adhesive.

According to the present invention, there is provided a head unit in which an inkjet head and a base can be bonded to each other in a state of being positioned with high accuracy, while resistance to ink is maintained.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a head unit according to a first embodiment.

FIG. 2 is an exploded perspective view of the head unit of FIG. 1.

FIG. 3 is a vertical sectional view of the head unit of FIG. 1.

FIG. 4 is an enlarged perspective view of a first bonding portion and its surroundings in the head unit of FIG. 1.

FIG. 5 is a cross-sectional view illustrating a state where second bonding portions and third bonding portions are formed in the head unit of FIG. 3.

FIG. 6 is a vertical sectional view of a head unit according to a second embodiment.

### DETAILED DESCRIPTION OF THE INVENTION

A first embodiment of the present invention will be described below with reference to drawings.

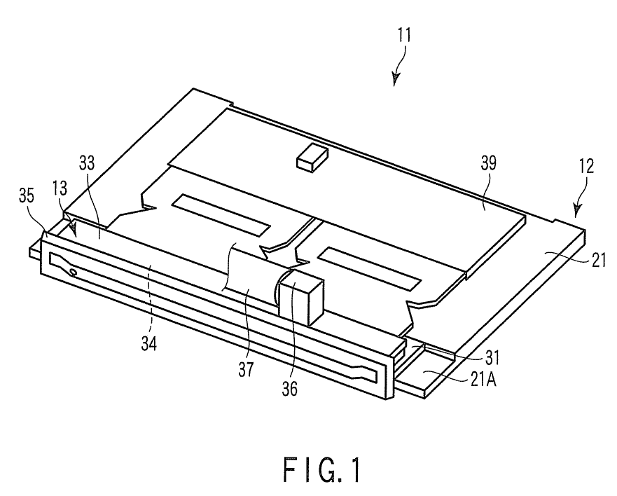

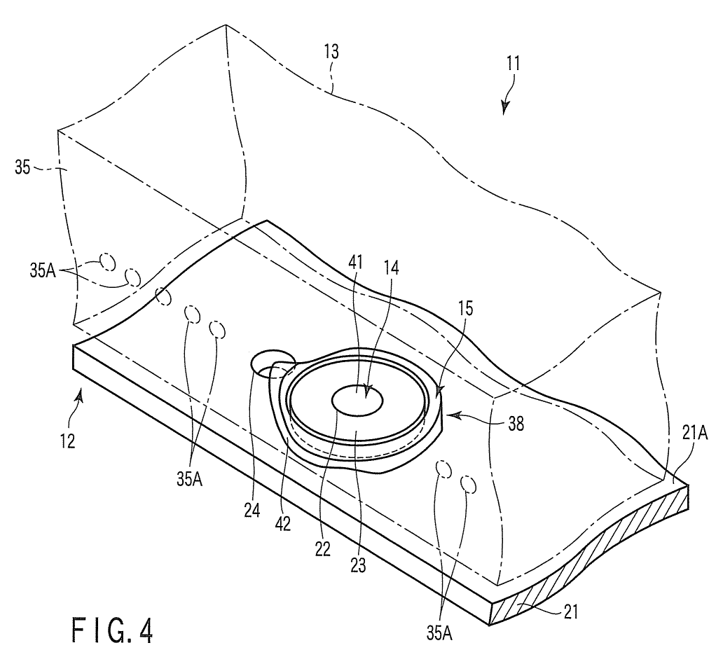

As illustrated in FIGS. 1 and 4, a head unit 11 has a base 12, an inkjet head 13 fixed to the base 12, a pair of first bonding portions 14 and a pair of second bonding portions 15, which bond the base 12 and the inkjet head 13.

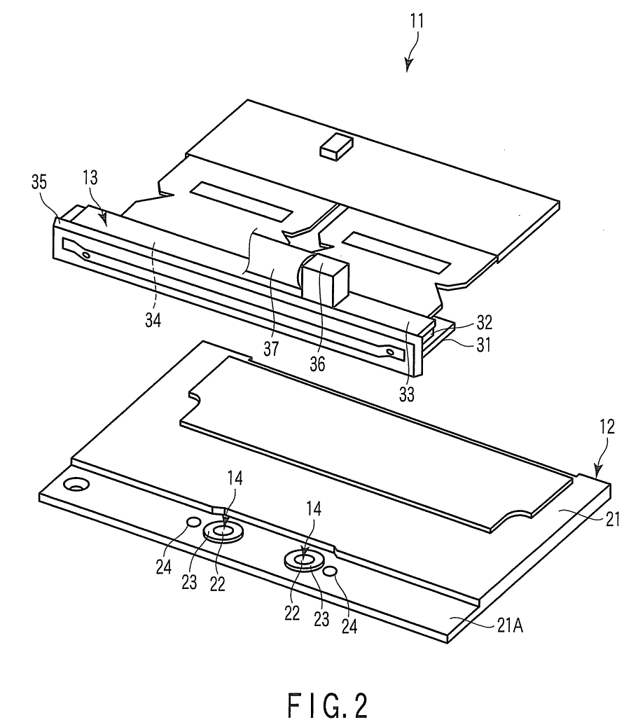

As illustrated in FIG. 2, the base 12 is formed of, for example, aluminum alloy having good thermal conductivity. The base 12 has a base main body 21 having a rectangular plate shape, a pair of first through holes 22 formed in a front portion of the base main body 21, cylindrical receiving portions 23 provided around the respective first through holes 22, and a pair of second through holes 24 provided outside and in the vicinity of the respective receiving portions 23. The base main body 21 has a mounting surface 21A in a front portion thereof, which is flat and lower than other portions by a step. The first through holes 22, the receiving portions 23, and the second through holes 24 are formed in the mounting surface 21A. The receiving portions 23 projects from the mounting surface 21A in a direction perpendicular to the mounting surface 21A. The material of the base 12 is not limited to aluminum alloy. The base 12 may be formed of, for example, magnesium alloy or the like, which has good thermal conductivity.

As illustrated in FIGS. 1 and 2, the inkjet head 13 has a bottom plate 31, a frame portion 32 attached to the bottom plate 31, a top plate 33 bonded to the frame portion 32, pressure chambers 34 which are formed in an internal space surrounded by the bottom plate 31, the frame portion 32, and the top plate 33, and sidewalls which separate the pressure chambers 34 from one another and serve as driving elements to discharge ink droplets, a nozzle plate 35 which has nozzles 35A communicating with the pressure chambers 34, an ink supply port 36 formed on the top plate 33, and a head drive board 39 which is electrically connected to the sidewalls. The ink supply port 36 is connected to an ink tank (not shown) through an ink channel 37. Although not shown, each of the sidewalls is formed by bonding two piezoelectric elements having opposed polarization directions.

Explained below is ink droplet discharge operation when the inkjet head 13 is mounted on an inkjet recording apparatus. When the inkjet recording apparatus starts printing in a state where liquid ink is filled in the pressure chambers 34, a control section of the inkjet recording apparatus outputs a print signal for the inkjet head 13 to the head drive board 39. The head drive board 39 which has received the print signal applies a pulse voltage to the sidewalls being drive elements. Thereby, a pair of right and left sidewalls which hold the pressure chamber 34 therebetween perform shared deformation, and are curved away from each other. Then, these sidewalls are returned to their original positions to pressurize the liquid in the pressure chamber 34, and thereby ink droplets are burst out of the nozzles 35A.

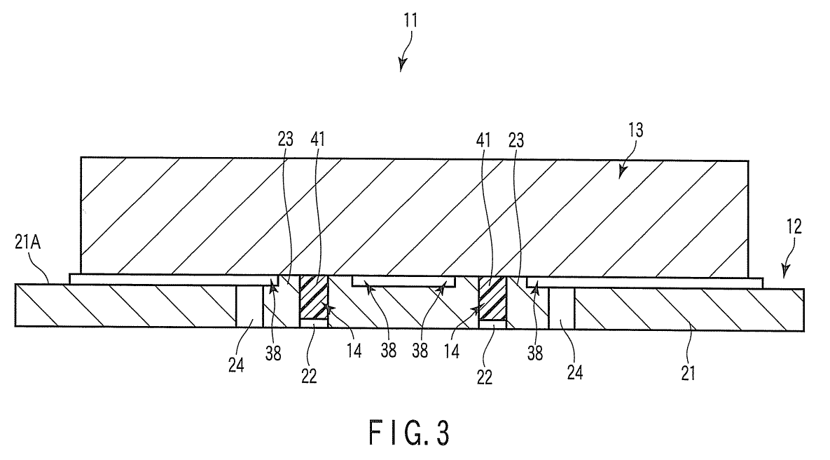

As illustrated in FIG. 3, spaces 38 are formed between the inkjet head 13 and the base 12. The spaces 38 are arranged to surround the first bonding portions 14. The spaces 38 are formed to have an annular shape around the first bonding portions 14 and the receiving portions 23. The ink is formed of, for example, solvent-based ink using a solvent, but is not limited to it. The ink may be a UV ink which is cured by irradiation of ultraviolet light after application, an aqueous water-based ink, or an oleaginous oil-based ink.

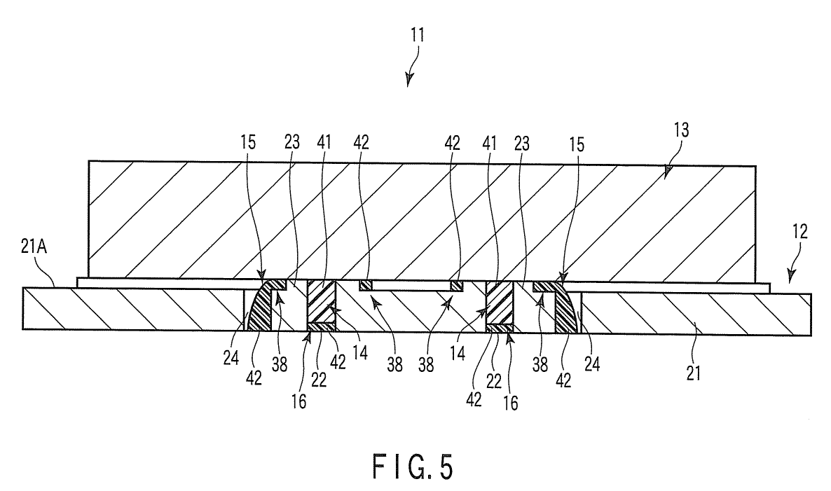

In the first embodiment, as illustrated in FIGS. 2 and 5, the first bonding portions 14 and the second bonding portions 15 are formed between the base 12 and the inkjet head 13. The first bonding portions 14 and the second bonding portions 15 are arranged in positions close to the center portion on the mounting surface 21A of the base 12.

The first bonding portions 14 are formed of, for example, a UV (ultraviolet)-curable first adhesive 41, and bonds the base 12 to the inkjet head 13 in a spot manner. The first adhesive 41 is curable at room temperature by irradiation of ultraviolet light. The first bonding portions 14 are formed inside the first through holes 22 and on upper surfaces of the receiving portions 23. The first adhesive 41 forming the first bonding portions 14 is not limited to UV-curable adhesives. The first adhesive 41 may be a synthetic-rubber-based adhesive which is cured by volatilization of moisture or solvent, an instantaneous adhesive which is cured by reaction with moisture, a two-liquid reaction curable adhesive which is cured by chemical reaction between a main agent and a hardener, or an anaerobic adhesive which is cured by shutoff of the air.

As illustrated in FIGS. 4 and 5, the second bonding portions 15 are formed on internal surfaces of the second through holes 24, and in positions surrounding the first bonding portions 14 and the receiving portions 23. Specifically, the second bonding portions 15 are formed to have an annular shape around the respective receiving portions 23, and bond the base 12 to the inkjet head 13. The second bonding portions 15 are formed of, for example, an epoxy-based thermosetting second adhesive 42. The epoxy-based thermosetting second adhesive 42 is a two-liquid adhesive, which is used by mixing a main agent and a hardener. The second adhesive 42 has resistance (corrosion resistance) to solvent-based inks, UV inks, water-based inks, and oil-based inks. As illustrated in FIG. 5, third bonding portions 16 are formed inside the first through holes 22 and in positions covering the surface of the first adhesive 41. The third bonding portions 16 are also formed of the second adhesive 42, like the second bonding portions 15.

Next, an assembly process of the head unit 11 according to the first embodiment is explained, with reference to FIGS. 3 to 5. The inkjet head 13 is positioned in a predetermined position on the base 12, and the UV-curable first adhesive 41 is applied inside the first through holes 22 of the base 12, as illustrated in FIG. 3. Ultraviolet light is applied to the inkjet head 13 and the base 12 in this state, and thereby the first adhesive 41 is cured. Thereby, the first bonding portions 14 are formed inside the first through holes 22 and on the upper surfaces of the receiving portions 23.

Then, the thermosetting second adhesive 42 is applied inside the second through holes 24 located in the vicinity of the first through holes 22 and the first adhesive 41. In the same manner, the thermosetting second adhesive 42 is applied on the surface of the first adhesive 41 in the first through holes 22. The head unit 11 in this state is put into an oven, and heated in a heating step. The heating step is performed by leaving the head unit 11 in the oven at 60 to 80° C. for a predetermined time. In the heating step, when the temperature of the second adhesive 42 rises, the viscosity of the second adhesive 42 decreases, and the flowability thereof increases. Thereby, the second adhesive 42 enters the spaces 38 between the base 12 and the inkjet head 13 by capillary action, around the first bonding portions 14 and the receiving portions 23. In this state, the second adhesive 42 is cured. Thereby, as illustrated in FIGS. 4 and 5, the second bonding portions 15 are formed to surround and seal the first bonding portions 14 and the receiving portions 23. Further, the third bonding portions 16 are formed on the surface of the first adhesive 41 in the first through holes 22. The heating step is preferably performed at a minimum temperature at which the second adhesive 42 is cured by heat, to reduce influence on the head unit caused by thermal expansion of the base 12 and the inkjet head 13 to a minimum.

According to the first embodiment of the head unit 11 as described above, the head unit 11 comprises the base 12, the inkjet head 13 which is attached to the base 12 and can discharge ink droplets, the first bonding portions 14 which bond the base 12 to the inkjet head 13 in a spot manner, and the second bonding portions 15 which are arranged to surround the first bonding portions 14, bond the base 12 to the inkjet head 13, and has resistance to ink.

According to the above structure, the first bonding portions 14 are surrounded by the ink-resistant second bonding portions 15. Therefore, when the ink is a solvent-based ink or the like, it is possible to prevent the first bonding portions 14 from being corroded by ink and from flaking off and swelling.

In this case, the first bonding portions 14 are formed of an adhesive which is curable at room temperature. According to this structure, it is unnecessary to separately perform a heating step for curing the first bonding portions 14, and it is possible to simply bond the base 12 to the inkjet head 13 with high accuracy.

In this case, the second bonding portions 15 are formed of a thermosetting adhesive. Generally, thermosetting adhesives have resistance to various inks. According to the above structure, it is possible to form ink-resistant bonding portions with relative ease.

In this case, the spaces 38 which are arranged to surround the first bonding portions 14 are formed between the base 12 and the inkjet head 13.

When the thermosetting second adhesive 42 is heated, the viscosity of the second adhesive 42 decreases, and the flowability thereof increases. According to this structure, since the spaces 38 which surround the first bonding portions 14 are formed between the base 12 and the inkjet head 13, the second adhesive 42 can flow into the spaces 38 by capillary action when the second bonding portions 15 are cured by heat. Thereby, portions around the first bonding portions 14 can be sealed with accuracy by the ink-resistant second bonding portions 15, and thus it is possible to prevent the first bonding portions 14 from being corroded by ink.

In this case, the second adhesive 42 is applied after the first adhesive 41 is cured. According to this structure, the second adhesive 42 is applied in the state where the base 12 and the inkjet head 13 are positioned by the first bonding portions 14. Therefore, even when the second bonding portions 15 are formed of a thermosetting adhesive, it is possible to prevent displacement between the inkjet head 13 and the base 12 in the heating step.

In this case, the first bonding portions 14 and the second bonding portions 15 are arranged in positions close to the center portion of the base 12.

According to this structure, it is possible to reduce the adverse effect due to difference in the coefficient of linear expansion between the base 12 and the inkjet head 13. Specifically, to cure the second adhesive 42 by heat, it is necessary to apply heat to the base 12 and the inkjet head 13. In this step, in the state where heat is applied, distortion caused by difference in the expansion amount occurs between the base 12 and the inkjet head 13, which is more noticeable in positions away from the center of the base 12. According to the above structure, the first bonding portions 14 and the second bonding portions 15 are arranged close to the center portion, where influence by such distortion is small. Therefore, when the head unit 11 is returned to room temperature after curing by heat, it is possible to prevent warping of the head unit 11, displacement of the inkjet head 13, and flaking of the first bonding portions 14.

In addition, according to the method of manufacturing a head unit of the first embodiment, the first adhesive 41 which is curable at room temperature is applied between the base 12 and the inkjet head 13 and cured at room temperature, then the thermosetting second adhesive 42 is applied to portions located in the vicinity of the first adhesive 41, and the head unit 11 is heated to cure the second adhesive 42 to surround the first adhesive 41.

According to the above structure, the second adhesive 42 can be cured by heat, in the state where the base 12 and the inkjet head 13 are positioned by the first adhesive 41 which is curable at room temperature. Therefore, it is possible to prevent displacement of the base 12 and the inkjet head 13 in curing by heat.

In this case, the second adhesive 42 has resistance to ink. According to this structure, the first bonding portions 14 can be sealed by an adhesive having resistance to ink. Therefore, when the ink is a solvent-based ink, it is possible to prevent the first adhesive 41 from being corroded by the ink.

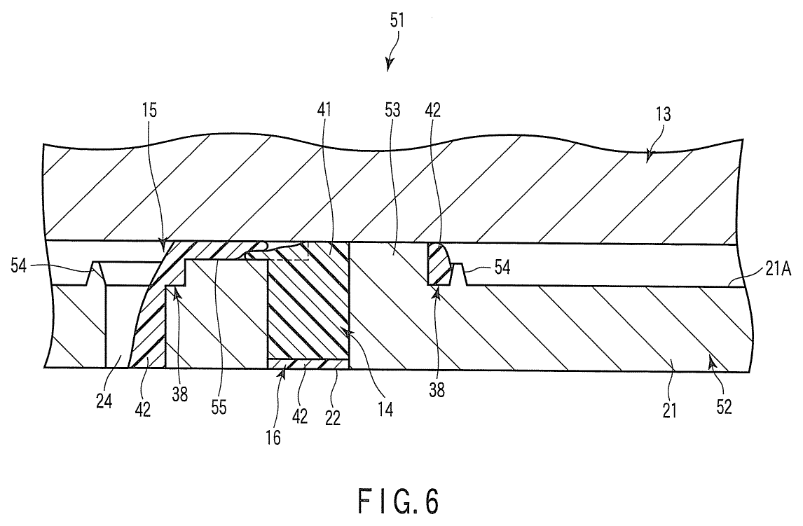

Next, a second embodiment of the present invention including a head unit 51 is explained with reference to FIG. 6. Although the head unit 51 according to the second embodiment is different from the first embodiment in the shape of a base 52 and the like, other constituent elements thereof are the same as those in the first embodiment. Therefore, the constituent elements of the second embodiment different from the first embodiment are mainly explained, and constituent elements common to the first and the second embodiments are denoted by the same respective reference numbers, and explanation thereof is omitted.

As illustrated in FIG. 2, the base 52 is formed of, for example, aluminum alloy having good heat conductivity. The base 52 has a base main body 21 having a rectangular plate shape, a pair of first through holes 22 formed in a front portion of the base main body 21, cylindrical receiving portions 53 provided around the respective first through holes 22, a pair of second through holes 24 provided outside and in the vicinity of the respective receiving portions 53, and projecting portions 54 formed around the second through holes 24. The base main body 21 also has a mounting surface 21A in a front portion, which is flat and lower than other portions by a step. The first through holes 22, the receiving portions 53, the second through holes 24, and the projecting portions 54 are formed in the mounting surface 21A. The receiving portions 53 and the projecting portions 54 project from the mounting surface 21A in a direction perpendicular to the mounting surface 21A.

The projecting portions 54 are formed to have an annular shape on the mounting surface, and surround the respective first bonding portions 14, the receiving portions 53, and the second through holes 24. Unlike the first embodiment, each of the receiving portions 53 has a clearance portion 55 formed by cutting off a part of the receiving portion 53 in the outside direction of the base 52. The material of the base 12 is not limited to aluminum alloy. The base 12 may be formed of, for example, magnesium alloy or the like, which has good thermal conductivity.

Next, an assembly process of the head unit 51 according to the second embodiment is explained with reference to FIG. 6. The inkjet head 51 is positioned in a predetermined position on the base 52, and a UV-curable (first) adhesive 41 is applied inside the first through holes 22 of the base 52, as illustrated in FIG. 6. In this step, part of the first adhesive 41 also enters the clearance portions 55. Ultraviolet light is applied to the inkjet head 13 and the base 52 in this state, and thereby the first adhesive 41 is cured. Thereby, the first bonding portions 14 are formed inside the first through holes 22 and on the upper surfaces of the receiving portions 53. Curing may be accelerated by heating the inkjet head 13 and the base 52 at low temperature, to cure the first adhesive 41 which has entered the clearance portions 55.

Then, a thermosetting second adhesive 42 is applied inside the second through holes 24 located in the vicinity of the first through holes 22 and the first adhesive 41. Further, the thermosetting second adhesive 42 is applied on the surface of the first adhesive 41 in the first through holes 22. The head unit 51 in this state is put into an oven, and heated in a heating step. The heating step is performed by leaving the head unit 51 in the oven at 60 to 80° C. for a predetermined time. In the heating step, when the temperature of the second adhesive 42 rises, the viscosity of the second adhesive 42 decreases, and the flowability thereof increases. In this state, by the projecting portions 54, the second adhesive 42 having increased flowability is kept staying around the first bonding portions 14 and the receiving portions 53. The second adhesive 42 enters spaces 38 between the base 52 and the inkjet head 13 by capillary action, around the first bonding portions 14 and the receiving portions 53. In this state, curing of the second adhesive 42 is accelerated. Second bonding portions 15 are formed to surround and seal the first bonding portions 14 and the receiving portions 53. Further, third bonding portions 16 are formed on the surface of the first adhesive 41 in the first through holes 22.

According to the second embodiment, the base 52 has the projecting portions 54 surrounding the first bonding portions 14. The projecting portions 54 permits the second adhesive 42 to stay around the first bonding portions 14. According to this structure, it is possible to prevent the thermosetting second adhesive 42 from flowing out of the surroundings of the first bonding portions 14 in the heating step. Thereby, the surroundings of the first bonding portions 14 can be sealed by the second bonding portions 15, and it is possible to prevent the first bonding portions 14 from being corroded by ink. Further, since there is no fear that the second adhesive 42 flows to ambient portions, it becomes unnecessary to strictly manage the application amount of the second adhesive 42.

The present invention is not limited to the above embodiments. Specifically, although only one inkjet head 13 is mounted on the base 12 or 52 in the above embodiments, a plurality of inkjet heads 13 may be mounted on one base 12 or 52. In addition, it goes without saying that the present invention can be carried out with various modifications within a range not departing from the gist of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A head unit comprising:
a base;
an inkjet head which is attached to the base and discharges ink droplets;
a first bonding portion which bonds the base to the inkjet head in a spot manner; and
a second bonding portion which is disposed to surround the first bonding portion, bonds the base to the inkjet head, and has resistance to ink.

2. A head unit according to claim 1, wherein the first bonding portion is formed of a first adhesive which is curable at room temperature.

3. A head unit according to claim 2, wherein the second bonding portion is formed of a thermosetting second adhesive.

4. A head unit according to claim 3, wherein a space which is disposed to surround the first bonding portion is formed between the base and the inkjet head.

5. A head unit according to claim 4, wherein the second adhesive is applied after the first adhesive is cured.

6. A head unit according to claim 5, wherein the first bonding portion and the second bonding portion are arranged in positions close to a center portion of the base.

7. A head unit according to claim 6, wherein the base has a projecting portion which surrounds the first bonding portion, and the projecting portion permits the second adhesive to stay around the first bonding portion.

8. A method of manufacturing a head unit having a base and an inkjet head attached to the base, comprising: applying a first adhesive, which is curable at room temperature, between the base and the inkjet head, curing the first adhesive at room temperature, thereafter applying a thermosetting second adhesive in the vicinity of the first adhesive, and heating the head unit and thereby curing the second adhesive to surround the first adhesive.

9. A method according to claim 8, wherein the second adhesive has resistance to ink.

10. A method according to claim 9, wherein a space which is disposed to surround the first adhesive is formed between the base and the inkjet head.

11. An inkjet unit comprising:
support means;
inkjet means, attached to the support means, for discharging ink droplets;
first bonding means for bonding the support means to the inkjet means in a spot manner; and
second bonding means, disposed to surround the first bonding means and having resistance to ink, for bonding the support means to the inkjet means.

12. An inkjet unit according to claim 11, wherein the first bonding means is formed of a first adhesive which is curable at room temperature.

13. An inkjet unit according to claim 12, wherein the second bonding means is formed of a thermosetting second adhesive.

14. An inkjet unit according to claim 13, wherein a space which is disposed to surround the first bonding means is formed between the support means and the inkjet means.

15. An inkjet unit according to claim 14, wherein the second adhesive is applied after the first adhesive is cured.

16. An inkjet unit according to claim 15, wherein the first bonding means and the second bonding means are arranged in positions close to a center portion of the support means.

17. An inkjet unit according to claim 16, wherein the support means has projecting means for surrounding the first bonding means, and the projecting means permits the second adhesive to stay around the first bonding means.
